(19) United States
(12) Patent Application Publication
(10) Pub. No.: US 2007/0050288 A1
(43) Pub. Date: Mar. 1, 2007

(54) System and method for integrating risk and marketing objectives for making credit offers

(75) Inventors: Abhinanda Sarkar, Bangalore (IN); Debasis Bal, Bangalore (IN); Subrat Nanda, New Delhi (IN)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: General Electric Company

(21) Appl. No.: 11/216,797

(22) Filed: Aug. 31, 2005

(51) Int. Cl. G06Q 40/00; G06Q 30/00

(52) U.S. Cl. 705/38; 705/14

(57) ABSTRACT

A system for integrating business risk and marketing objectives into a unified business strategy for providing credit to one or more members of a target population is provided. The system comprises a database comprising risk data and marketing data associated with the members of the target population and a scoring model that receives the risk data and the marketing data from the database. The scoring model generates a set of risk scores and a set of marketing scores associated with the members of the target population over a range of additional credit that could be provided to the members of the target population. The system further comprises a network model and an optimization model. The network model collectively uses the risk scores and the marketing scores from the scoring model and generates a probability distribution of expected use of the credit over the range of additional credit that could be provided to the target population. The optimization model receives the distribution of expected use of the credit from the network model and determines the level of credit to offer the members of the target population in order to maximize a business measure subject to a set of business constraints.

### BACKGROUND OF THE INVENTION

The invention relates generally to customer relationship management (CRM) and more particularly to a system and method for providing credit to members of a target population using an integrated business risk and marketing strategy.

There are a number of distinct analytical processes that consumer or retail finance organizations routinely undertake. Of major importance is the “risk” or “credit scoring” process in which customers are scored according to their propensity to remain in good financial standing and not default on obligations. The risk scoring process in general may be based on several factors, such as the customer's credit risk profile, his/her income, his/her profit potential, the offered product and the credit policies of the finance organization. Also of significant value is the computation of “response scores” for marketing campaigns, which are dedicated to identifying high-potential current or future customers, “high potential” being defined by a favorable likelihood of response of a consumer to a new offer of credit. A number of statistical analysis approaches have been used to define the characteristics that are most predictive of a consumer's future behavior.

Traditionally, banks and financial institutions have kept the risk management and customer relationship management functions as separate entities. The decisions that involve both are usually taken at a higher administrative level, often in an ad-hoc fashion. Risk management is traditionally based on identifying customers that have a propensity to remain in good financial standing and not default on obligations, or in other words, that have a minimum risk of default. On the other hand, customer relationship management is based on identifying high-potential current or future customers and may not necessarily have a low risk of default. However, in the current highly competitive consumer finance world, the need to market aggressively to moderate risk individuals and households can be business-critical. Therefore, conflicting goals between risk and marketing may often arise, resulting in a non-unified risk and marketing strategy.

Therefore, there is a need for a system and method that can leverage both risk and marketing aspects of a financial relationship. In addition, there is a need for a system and method that can serve to recommend business actions that can optimize both these aspects and provide an analytical framework for making collective decisions on routine processes such as pricing of a financial product and determining the creditworthiness of the members of a target population.

### BRIEF DESCRIPTION

Embodiments of the present invention address this and other needs. In one embodiment, a method for integrating business risk and marketing objectives into a unified business strategy for providing credit to one or more members of a target population is provided. The method comprises collecting risk data and marketing data associated with the members of the target population and building a scoring model from the risk data and the marketing data by generating a set of risk scores and a set of marketing scores associated with the members of the target population over a range of credit that could be provided to the members of the target population. Then, the method comprises collectively using the risk scores and the marketing scores in a network model, wherein the network model generates a probability distribution of expected use of the credit over the range of credit that could be provided to the target population. Finally, the method comprises generating an optimized risk and marketing strategy for selecting the amount of credit to provide to the members of the target population based on the probability of expected use generated by the network model.

In another embodiment, a system for integrating business risk and marketing objectives into a unified business strategy for providing credit to one or more members of a target population is provided. The system comprises a database comprising risk data and marketing data associated with the members of the target population and a scoring model that receives the risk data and the marketing data from the database. The scoring model generates a set of risk scores and a set of marketing scores associated with the members of the target population over a range of credit that could be provided to the members of the target population. The system further comprises a network model and an optimization model. The network model collectively uses the risk scores and the marketing scores from the scoring model and generates a probability distribution of expected use of the credit for the range of credit that could be provided to the target population. The optimization model receives the distribution of expected use of the credit from the network model and determines the level of credit to offer the members of the target population in order to maximize a business measure subject to a set of business constraints.

### DRAWINGS

These and other features, aspects, and advantages of the present invention will become better understood when the following detailed description is read with reference to the accompanying drawings in which like characters represent like parts throughout the drawings, wherein:

FIG. 1 is an illustration of a high-level architecture of a system for integrating business risk and marketing objectives into a unified business strategy for providing credit to members of a target population in accordance with one embodiment of the present invention;

FIG. 2 is an exemplary illustration of a network model in the form of a Bayesian Belief Network, for determining a distribution of expected use of the credit for the members of the target population; and

FIG. 3 is a flowchart of exemplary logic, including exemplary steps for integrating business risk and marketing objectives into a unified business strategy, in accordance with one embodiment of the present invention.

### DETAILED DESCRIPTION

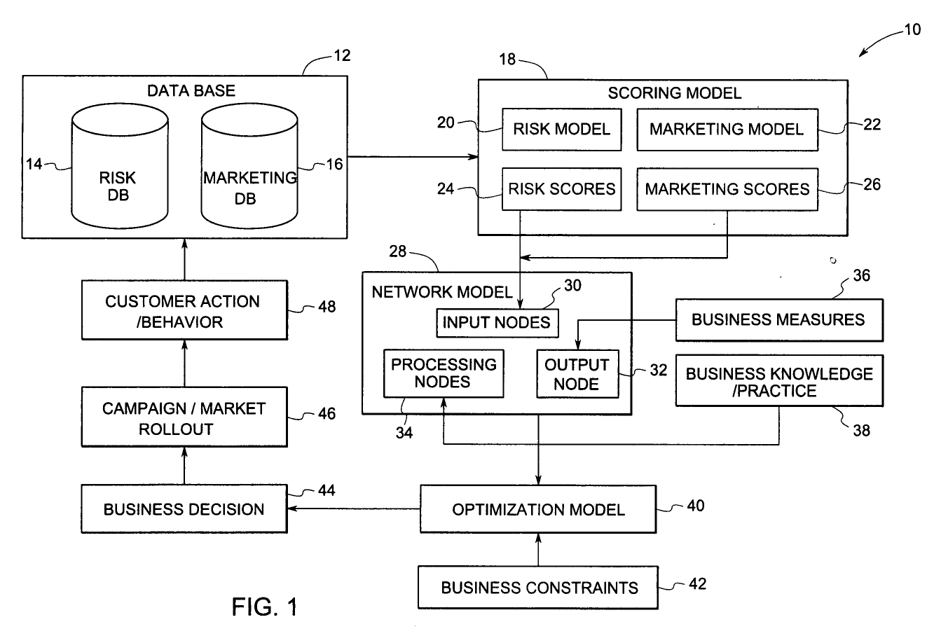

FIG. 1 is an illustration of a high-level architecture of a system for integrating business risk and marketing objectives into a unified business strategy for providing credit to members of a target population, in accordance with one embodiment of the present invention. As shown in FIG. 1, the system 10 generally includes a database 12, a scoring model 18, a network model 28 and an optimization model 40.

In a particular embodiment, the database 12 includes a risk database 14 and a marketing database 16. The risk database 14 includes risk data associated with the members of the target population. The risk data may include demographic data, transaction level data and account level data associated with the members of the target population. As used herein, “transaction level data” refers to data pertaining to transaction events such as debits; credits as well as failure events like missed repayments on the account through any channel. In particular, the risk data may include, information about a member/customer's job profile and his/her position held in the job, his/her credit history, the number of years of residence of the customer at his/her current address, his/her income statement, the bank accounts and the life insurance policies of the customer and the loan repayment history of the customer. One of ordinary skill in the art will recognize that the above examples are exemplary illustrations of the types of risk data that may be stored in the risk database 14 and are not meant to limit other types of risk information that may be stored in the risk database 14.

The marketing database 16 includes marketing data associated with the target population. The marketing data may include metrics for measuring and maximizing the profitability of the one or more customers/members of the target population. The metrics for measuring the profitability may include business measures such as, balance, income, contributed value, expected dollars of use, dollars of credit offered, and number of people receiving additional credit. The marketing data may also include business objectives/strategies for managing the existing customer base and strategies for expanding the customer base (such as, through channel strategies or product strategies). Again, one of ordinary skill in the art will recognize that the above examples are exemplary illustrations of the types of marketing data that may be stored in the marketing database 16 and are not meant to limit other types of marketing information that may be stored in the marketing database 16.

Referring again to FIG. 1, the risk data and the marketing data are then input into a scoring model 18. In accordance with the present embodiment, the scoring model 18 receives the risk data and the marketing data from the risk database 14 and the marketing database 16 respectively, and determines a set of risk scores 24 and a set of marketing scores 26 associated with the members of the target population over a range of credit that could be provided to the members of the target population. The “range of credit” may be determined based on a number of factors, such as, for example overall credit portfolio strategy of the business, specific business objectives and constraints, distribution of the target population in meaningful and actionable segments, shift of population characteristics over time etc.

In a particular embodiment, and as shown in FIG. 1, the scoring model 18 includes a risk model 20 that generates a set of risk scores or behavioral scores 24 based on the risk data and a marketing model 22 that generates a set of marketing scores or response scores 26 based on the marketing data. As used herein, the “risk scores” are representative of a default probability on a financial product of a member from the target population and the “marketing scores” are representative of a probability of expected use of a financial product of a member from the target population. For example, a risk score of 210 on a scale of 0 to 1000 for a member from the target population may represent a relatively high likelihood of default on a debt within three years. Similarly a response score of 731 on a scale of 0 to 1000 for a member from the target population may represent a relatively high likelihood of the member actually subscribing to the offer. A number of scoring models are known in the art and may be used by the risk model 20 and the marketing model 22 to generate the set of risk scores 24 and the set of marketing scores 26 respectively. These models include, but are not limited to, parametric models (such as for example: regression models, linear probability models, discrimination analysis models, etc.) and non-parametric models (such as for example: mathematical programming models, classification trees and expert systems).

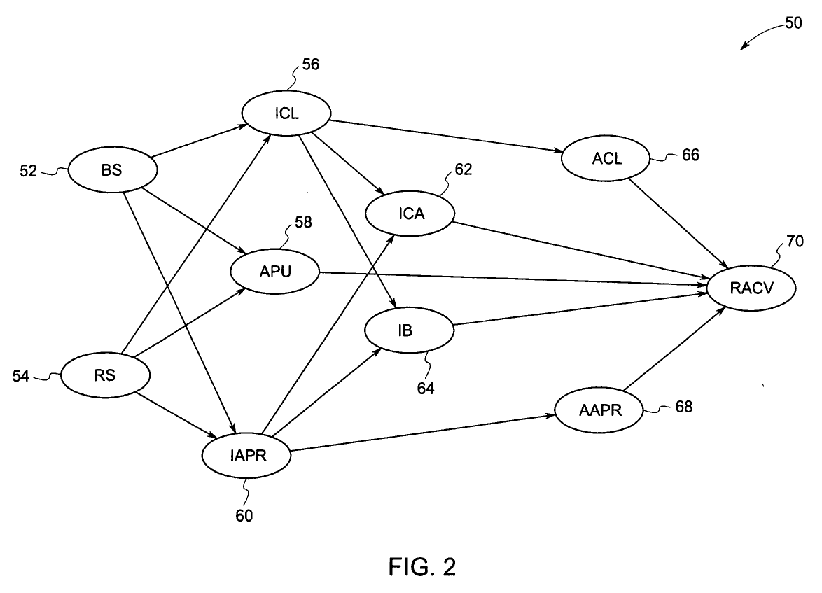

The risk scores 24 and the marketing scores 26 are then input into a network model 28. In accordance with one embodiment, the network model 28 is represented by a Bayesian Belief Network (BBN), and will be described in greater detail with respect to FIG. 2 below. Referring to FIG. 1, the network model 28 includes one or more input nodes 30, one or more processing nodes 34 (action or decision nodes) and an output node 32. In a particular embodiment, and as will be described in greater detail below, the input nodes represent the risk scores 24 and the marketing scores 26 generated by the scoring model 18. The processing nodes 34 include information about business knowledge and practices 38 associated with the financial organization such as credit settings, annual percentage rates and prices, etc. The output node 32 includes information about one or more business measures 36 to be optimized, such as for example, balance, income, contributed value, expected dollars of use, dollars of credit offered, and number of people receiving additional credit.

In a particular embodiment of the present invention, and as will be described in greater detail with respect to FIG. 2 below, the network model 28 receives both the risk scores 24 and the marketing scores 26 from the scoring model 18 and collectively uses the risk scores and the marketing scores to generate a probability distribution of expected use of the credit that could be provided to the members of the target population over a range of possible credit.

The optimization model 40 receives the distribution of expected use of the credit from the network model 28 and determines the level of credit to offer the members of the target population in order to maximize a business measure subject to a set of business constraints. In one embodiment, the optimization module uses a mixed integer program to perform the optimization. Further, in accordance with the present technique, the credit offered to a member of the target population, may be derived based on several factors such as, the initial credit line, the repayment terms and the interest rates associated with the individual. Therefore, level of credit that could be offered to a member of the target population may result in an increase or a decrease in the credit amount to be offered to an individual. In a particular embodiment, the optimization model 40 optimizes the risk adjusted contributed value (RACV) subject to one or more business constraints 42 to arrive at a business decision 44. In accordance with one embodiment, the business constraints 42 include constraints on the total amount of credit available for the members of the target population, the interest rate, the total size of the target population receiving credit and the total allowable risk level. The business decision 44 may include a decision on the amount of credit that can be provided to the members of the target population based on the probability of expected use generated by the network model.

Following an appropriate business decision 44, a Campaign/Market Rollout 46 may be performed as a means to implement the business decision 44. The implementation may be through mass communication media, advertising, or by a display of the financial products. Customer Action/Behavior 48 may also be observed during the campaign/market rollout process 46. Observations from the customer action/behavior 48 may then be used to update the risk data and the marketing data stored in the database 12. In certain embodiments, the customer action/behavior 48 may also be used to update the risk model 20, the marketing model 22, and the nodes in the network model 28 or the business Knowledge/Practice 38.

FIG. 2 is an exemplary illustration of a network model in the form of a Bayesian Belief Network 50 (BBN). As is known to those skilled in the art, a BBN 50 is generally represented as a directed graph comprising a plurality of nodes and arcs. The nodes represent discrete or continuous variables and the arcs represent causal relationships between the variables. Also, as is known to those skilled in the art, each node in the BBN 50 is generally associated with a probability table. The probability table for a node represents the probability of occurrence of all combinations of values that can be assigned to a node and its parent nodes. In accordance with the present embodiment, each probability value in the probability table is indicative of a range of possible values that can be assigned to each of the nodes in the BBN 50.

In accordance with an exemplary operation of the BBN 50 of the present invention, the distribution for the Initial Credit Line (ICL) 56 for a member/customer from the target population may be determined as follows. Referring to FIG. 2, the input nodes include a behavioral score (BS) node 52 and a response score node (RS) 54. Based on the joint probability distribution associated with the BS node 52 and the RS node 54, derived from their respective probability tables, the corresponding numerical score ranges for the nodes 52 and 54 is obtained. These scores along with the probability distribution associated with the ICL node 56 are used to derive the joint probability distribution of the initial credit line of a customer. The Average Primary Utilization (APU) 58 and Initial Annual Percentage Rate (IAPR) 60 for a customer may also be derived similarly. As used herein, the ICL 56 refers to a predetermined amount that a prospective customer has been pre-approved for. The APU 58 refers to the actual money used by the customer from his/her initial credit line (ICL) amount over a period of time. The IAPR 60 refers to the annual percentage rate that the customer pays for the use of the financial product, such as, for example, a financial loan. The relationship is modeled as shown in FIG. 2 with appropriate arcs.

Referring to FIG. 2 again, the BBN 50 includes one or more additional processing nodes, such as, for example, the Initial Contract Amount 62 (ICA) and the Initial Balance 64 (IB). As used herein, the ICA 62 refers to the amount that the customer signs up (through a legally valid contract document) for using out of his/her initial credit line and the IB 64 refers to the amount that is actually used by a customer, from his/her ICL 56. The ICA 62 for a customer is based on the numerical values of the ICL 56 and the IAPR 60 derived from their associated probability tables, along with the probability value associated with the ICL node. The IB 64 may also be similarly derived for a customer.

The Action Credit Line (ACL) 66 and the Action APR (AAPR) 68 represent decision variables and are also processing nodes in the BBN 50. Decision variables have a special significance vis-à-vis other nodes in the network. Whereas other nodes are historical state nodes, decision nodes can be used to represent multiple scenarios or alternatives. As shown in FIG. 2, the ACL 66 for a customer is based on the ICL 56 along with the probabilistic value associated with the ACL node 66 and the AAPR 68 for a customer is based on the IAPR 60 along with the probabilistic value associated with the AAPR 68.

The outcome of the BBN 50 is a distribution of expected profit or returns from the use of the credit for the members of the target population over the range of possible credit. As used herein, the “expected use of the credit” refers to the amount of usage or credit that is expected, or the amount of annual return in terms of the interest paid to a creditor for each dollar of credit that is offered to a particular demographic distribution. In one embodiment, the output is represented by a business measure to be optimized. In a particular embodiment, the business measure is a risk adjusted contributed value (RACV) 70. The RACV 70 refers to the contributed value (a measure of profit from the credit) that can be generated from the members of the target population keeping in mind the risk factor associated with the use of the financial product and at the same time meeting the expected level of profitability from each customer.

The network model, developed in accordance with the present invention, collectively uses the risk scores and the marketing scores in a single framework to arrive at a unified business strategy. As will be appreciated by those skilled in the art, marketing objectives are based on identifying different ways to attract and acquire new customers through customer management strategies, channel strategies, product strategies, promotional strategies, retention strategies and reactivation strategies. These strategies focus on retaining existing customers and increasing good balance and interest income. On the other hand, risk objectives are based on establishing a company wide portfolio and decreasing poor balance through new credit line strategies, credit line strategies for existing customers and collection strategies. The network model, developed in accordance with the present invention, integrates both risk and marketing strategies into a single decisioning platform by the collective use of both risk scores and marketing scores within a single framework.

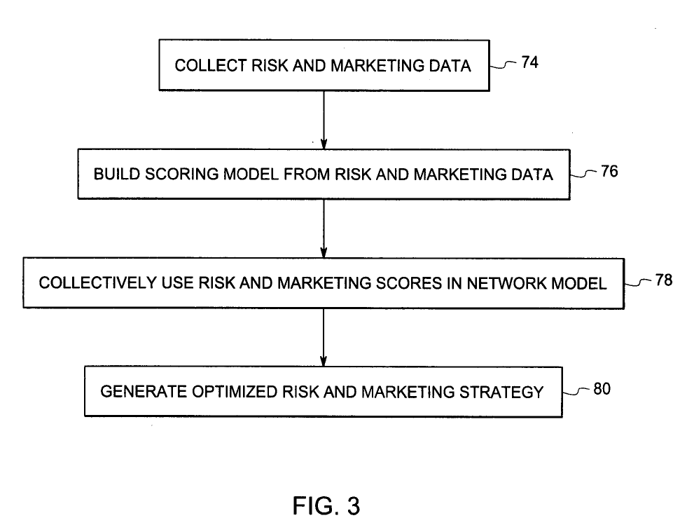

FIG. 3 is a flowchart of exemplary logic, including exemplary steps for integrating business risk and marketing objectives into a unified business strategy, in accordance with one embodiment of the present invention. In step 74, risk data and marketing data associated with the members of the target population is collected. As mentioned above, the risk data includes demographic data, transaction level data and account level data associated with members of the target population and the marketing data includes strategies for maximizing the profitability of the members of the target population. In step 76, a scoring model is built from the risk data and the marketing data. The scoring model generates a set of risk scores and a set of marketing scores associated with the members of the target population over a range of credit that could be provided to the members of the target population. As mentioned above, a number of parametric and non-parametric scoring models are known in the art and may be used by embodiments of the present invention to generate the risk scores and the marketing scores. In step 78, the risk scores and the marketing scores are collectively input in a network model. As described above, the network model generates a probability distribution of expected use of the credit over the range of credit that could be provided to the target population. In a particular embodiment, and as described in detail with respect to FIG. 2 above, the network model is represented as a BBN. In step 80, an optimized risk and marketing strategy for selecting the amount of credit to provide to the members of the target population based on the probability of expected use generated by the network model is generated. As described above, the optimized risk and marketing strategy selects the amount of credit to be provided to each member of the target population by maximizing a business measure subject to a set of business constraints.

As will be appreciated by those skilled in the art, the embodiments and applications illustrated and described above will typically include or be performed by appropriate executable code in a programmed computer. Such programming will comprise a listing of executable instructions for implementing logical functions. The listing can be embodied in any computer-readable medium for use by or in connection with a computer-based system that can retrieve, process and execute the instructions. Alternatively, some or all of the processing may be performed remotely by additional computing resources based upon raw or partially processed image data.

In the context of the present technique, the computer-readable medium is any means that can contain, store, communicate, propagate, transmit or transport the instructions. The computer readable medium can be an electronic, a magnetic, an optical, an electromagnetic, or an infrared system, apparatus, or device. An illustrative, but non-exhaustive list of computer-readable mediums can include an electrical connection (electronic) having one or more wires, a portable computer diskette (magnetic), a random access memory (RAM) (magnetic), a read-only memory (ROM) (magnetic), an erasable programmable read-only memory (EPROM or Flash memory) (magnetic), an optical fiber (optical), and a portable compact disc read-only memory (CDROM) (optical). Note that the computer readable medium may comprise paper or another suitable medium upon which the instructions are printed. For instance, the instructions can be electronically captured via optical scanning of the paper or other medium, then compiled, interpreted or otherwise processed in a suitable manner if necessary, and then stored in a computer memory.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A method for integrating business risk and marketing objectives into a unified business strategy for providing credit to one or more members of a target population, the method comprising:
collecting risk data and marketing data associated with the members of the target population;
building a scoring model from the risk data and the marketing data, wherein building the scoring model comprises generating a set of risk scores and a set of marketing scores associated with the members of the target population over a range of credit that could be provided to the members of the target population;
collectively using the risk scores and the marketing scores in a network model, wherein the network model generates a probability distribution of expected use of the credit over the range of credit that could be provided to the target population; and
generating an optimized risk and marketing strategy for selecting the amount of credit to provide to the members of the target population based on the probability of expected use generated by the network model.

2. The method of claim 1, wherein the risk data comprises demographic data, transaction level data and account level data associated with the members of the target population.

3. The method of claim 1, wherein the marketing data comprises metrics for measuring and maximizing the profitability of the one or more members of the target population.

4. The method of claim 1, wherein the risk scores are representative of a default probability on a financial product of a member from the target population.

5. The method of claim 1, wherein the marketing scores are representative of a probability of expected use of a financial product of a member from the target population.

6. The method of claim 1, wherein the scoring model comprises parametric models and non-parametric models.

7. The method of claim 1, wherein the network model is a Bayesian Belief Network (BBN).

8. The method of claim 7, wherein the network model integrates the risk scores and the marketing scores into a single decisioning platform.

9. The method of claim 1, wherein the optimized risk and marketing strategy comprises selecting the amount of credit for each member of the target population to maximize a business measure subject to a set of business constraints.

10. The method of claim 9, wherein the business constraints comprise at least one of total amount of credit for the target population, fixed interest rate, total size of the target population receiving credit and total allowable risk level.

11. The method of claim 9, wherein the business measure comprises at least one of a risk adjusted contributed value, expected dollars of use, dollars of credit offered, and number of people receiving additional credit.

12. A system for integrating business risk and marketing objectives into a unified business strategy for providing credit to one or more members of a target population, the system comprising:
a database comprising risk data and marketing data associated with the members of the target population;
a scoring model that receives the risk data and the marketing data from the database and generates a set of risk scores and a set of marketing scores associated with the members of the target population over a range of credit that could be provided to the members of the target population;
a network model that collectively uses the risk scores and the marketing scores from the scoring model and generates a probability distribution of expected use of the credit over the range of credit that could be provided to the target population; and
an optimization model that receives the distribution of expected use of the credit from the network model and determines the level of credit to offer the members of the target population in order to maximize a business measure subject to a set of business constraints.

13. The system of claim 12, wherein the risk data comprises demographic data, transaction level data and account level data associated with the members of the target population.

14. The system of claim 12, wherein the marketing data comprises metrics for measuring and maximizing the profitability of the one or more members of the target population.

15. The system of claim 12, wherein the risk scores are representative of a default probability on a financial product of a member from the target population.

16. The system of claim 12, wherein the marketing scores are representative of a probability of expected use of a financial product of a member from the target population.

17. The system of claim 12, wherein the network model is a Bayesian Belief Network (BBN).

18. The system of claim 17, wherein the network model integrates the risk scores and the marketing scores into a single decisioning platform

19. The system of claim 12, wherein the business constraints comprise at least one of total amount of credit for the target population, fixed interest rate, total size of the target population receiving credit and total allowable risk level.

20. The system of claim 12, wherein the business measure comprises at least one of a risk adjusted contributed value, expected dollars of use, dollars of credit offered, and number of people receiving additional credit.

21. A computer readable medium for integrating business risk and marketing objectives into a unified business strategy for providing credit to one or more members target population, the computer instructions comprising:
code for collecting risk data and marketing data associated with the members of the target population;
code for building a scoring model from the risk data and the marketing data, wherein building the scoring model comprises generating a set of risk scores and a set of marketing scores associated with the members of the target population over a range of credit that could be provided to the members of the target population;
code for collectively using the risk scores and the marketing scores in a network model, wherein the network model generates a probability distribution of expected use of the credit over the range of credit that could be provided to the target population; and
code for generating an optimized risk and marketing strategy for selecting the amount of credit to provide to the members of the target population based on the probability of expected use generated by the network model.
